(19) United States
(12) Patent Application Publication
(10) Pub. No.: US 2020/0408484 A1
(43) Pub. Date: Dec. 31, 2020

(54) FEEDING MECHANISM OF SHOOTING DEVICE, SHOOTING DEVICE AND UNMANNED AERIAL VEHICLE

(71) Applicant: SZ DJI TECHNOLOGY CO., LTD., Shenzhen (CN)

(72) Inventor: Guibin LIANG, Shenzhen (CN)

(21) Appl. No.: 17/017,178

(22) Filed: Sep. 10, 2020

Related U.S. Application Data
(63) Continuation of application No. PCT/CN2018/085054, filed on Apr. 28, 2018.

(51) Int. Cl. F41B 11/54; B64C 39/02; B64D 7/02

(52) U.S. Cl. CPC F41B 11/54; B64C 2201/12; B64D 7/02; B64C 39/024

(57) ABSTRACT

A feeding mechanism of a shooting device includes a feeding disk, a feeding wheel arranged at the feeding disk and including a feeding member, and a transmission assembly configured to drive the feeding wheel to rotate unidirectionally to cause the feeding member to push a projectile accommodated in the feeding disk to a projectile outlet.

### CROSS-REFERENCE TO RELATED APPLICATION

This application is a continuation of International Application No. PCT/CN2018/085054, filed on Apr. 28, 2018, the entire content of which is incorporated herein by reference.

### TECHNICAL FIELD

The present disclosure relates to the field of shooting and, more particularly, to a feeding mechanism of a shooting device, a shooting device, and an unmanned vehicle.

### BACKGROUND

A shooting device is a mechanical device that shoots out projectiles. The shooting device can be used in various applications, such as entertainment, competition, and the like. However, due to structural design defects of the shooting device, the phenomenon of missed shots of the projectiles, multiple shots of the projectiles, or crushing the projectiles is easy to occur, thereby reducing the shooting quality of the shooting device and causing a bad user experience.

### SUMMARY

In accordance with the disclosure, there is provided a feeding mechanism of a shooting device including a feeding disk, a feeding wheel arranged at the feeding disk and including a feeding member, and a transmission assembly configured to drive the feeding wheel to rotate unidirectionally to cause the feeding member to push a projectile accommodated in the feeding disk to a projectile outlet.

Also in accordance with the disclosure, there is provided a shooting device including a feeding mechanism including a feeding disk, a feeding wheel arranged at the feeding disk and including a feeding member, and a transmission assembly configured to drive the feeding wheel to rotate unidirectionally to cause the feeding member to push a projectile accommodated in the feeding disk to a projectile outlet.

Also in accordance with the disclosure, there is provided an unmanned vehicle including a body, a gimbal arranged at the body, and a shooting device arranged at the gimbal and including a feeding mechanism. The feeding mechanism includes a feeding mechanism including a feeding disk, a feeding wheel arranged at the feeding disk and including a feeding member, and a transmission assembly configured to drive the feeding wheel to rotate unidirectionally to cause the feeding member to push a projectile accommodated in the feeding disk to a projectile outlet.

### BRIEF DESCRIPTION OF THE DRAWINGS

The drawings used in the description of the disclosed embodiments are intended to provide a clearer illustration of the present disclosure.

FIG. 1 is a schematic perspective view of a shooting device consistent with embodiments of the disclosure.

FIG. 2 is a schematic perspective view of a feeding mechanism consistent with embodiments of the disclosure.

FIG. 3 is a schematic plan view of a feeding mechanism consistent with embodiments of the disclosure.

FIG. 4 is a schematic view showing an internal structure of a feeding mechanism consistent with embodiments of the disclosure.

FIG. 5 is a schematic view showing a partial structure of a feeding mechanism consistent with embodiments of the disclosure.

FIG. 6 is a partial perspective view of a feeding mechanism consistent with embodiments of the disclosure.

FIG. 7 is a schematic perspective view of a feeding mechanism from another angle consistent with embodiments of the disclosure.

FIG. 8 is a partially exploded view of a feeding mechanism consistent with embodiments of the disclosure.

FIG. 9 is another partial plan view of a feeding mechanism consistent with embodiments of the disclosure.

FIG. 10 is a schematic cross-sectional view of the feeding mechanism of FIG. 9 along an A-A direction.

FIG. 11 is another schematic view showing a partial structure of a feeding mechanism consistent with embodiments of the disclosure.

FIG. 12 a schematic perspective view of a feeding wheel of a feeding mechanism consistent with embodiments of the disclosure.

FIG. 13 is a schematic perspective view of a magazine of a feeding mechanism consistent with embodiments of the disclosure.

### DESCRIPTION OF MAIN COMPONENTS AND REFERENCE NUMERALS

| | |
|---|---|
| Feeding mechanism | 10 |
| Shooting device | 12 |
| Power member | 14 |
| Transmission assembly | 16 |
| Feeding wheel | 18 |
| Feeding disk | 20 |
| Feeding member | 22 |
| Projectile outlet | 24 |
| Hub | 26 |
| Gear teeth | 28 |
| Bottom wall | 30 |
| Side wall | 32 |
| Projectile-receiving groove | 34 |
| Unidirectional rotation member | 36 |
| First transmission member | 38 |
| Reference axis | L |
| First power member | 40 |
| Second power member | 42 |
| Stopper | 44 |
| Stopper engaging member | 46 |
| Second transmission member | 48 |
| Piston assembly | 50 |
| Piston transmission member | 52 |
| Piston cylinder | 54 |
| Piston | 56 |
| First projection | 58 |
| Second projection | 60 |
| Gear assembly | 62 |
| Rack | 64 |
| Projectile inlet | 66 |
| Shield member | 68 |
| Magazine | 70 |
| Blocking member | 72 |
| Three-way pipe | 74 |
| First reset spring | 76 |
| Second reset spring | 78 |
| Barrel | 80 |

### DETAILED DESCRIPTION OF THE EMBODIMENTS

Exemplary embodiments will be described with reference to the accompanying drawings, in which the same numbers refer to the same or similar elements unless otherwise specified. The disclosed embodiments are merely exemplary and not intended to limit the scope of the disclosure.

As used herein, the terms “center,” “portrait,” “landscape,” “length,” “width,” “thickness,” “top,” “bottom,” “front,” “rear,” “left,” “right,” “vertical,” “horizontal,” “top,” “bottom,” “inside,” “outside,” “clockwise,” “counterclockwise,” and the like, indicate the orientation or positional relationship shown in the disclosed drawings. These terms are merely for the purposes of description and simplification, and do not indicate or imply the device or element having the specific orientation and/or being constructed or operated in the specific orientation. Therefore, these terms are not intended to limit the present disclosure. The terms “first,” “second,” or the like in the specification, claims, and the drawings of the disclosure are merely illustrative, e.g., distinguishing similar elements, defining technical features, or the like, and are not intended to indicate or imply the importance of the corresponding elements or the number of the technical features. Thus, features associated with “first” and “second” may explicitly or implicitly include one or more of the features. As used herein, “multiple” means two or more, unless otherwise specified.

As used herein, the terms “mounted,” “coupled,” and “connected” should be interpreted broadly, unless otherwise specified. For example, the connection between two assemblies may be a fixed connection, a detachable connection, or an integral connection. The connection may also be a mechanical connection, an electrical connection, or a mutual communication connection. Furthermore, the connection may be a direct connection or an indirect connection via an intermedium, an internal connection between the two assemblies or an interaction between the two assemblies.

As used herein, unless otherwise specified, when a first component is referred to as “above” or “below” a second component, it is intended that the first component may be directly attached to the second component or may be indirectly attached to the second component via another component. When the first component is referred to as “over,” “above,” or “on top of” the second component, it is intended that the first component may be directly above or obliquely above the second component, or merely that a horizontal height of the first component may be higher than a horizontal height of the second component. When the first component is referred to as “below,” “under,” or “on bottom of” the second component, it is intended that the first component may be directly below or obliquely below the second component, or merely that the horizontal height of the first component may be lower than the horizontal height of the second component.

Various exemplary embodiments corresponding to different implementations of the disclosure will be described. For simplification purposes, the elements and configurations for the specific embodiments are described below. It will be appreciated that the described embodiments are exemplary only and not intended to limit the scope of the disclosure. Moreover, the references of numbers or letters in various exemplary embodiments are merely for the purposes of clear and simplification, and do not indicate the relationship between the various exemplary embodiments and/or configurations. In addition, the use of other processes and/or materials will be apparent to those skilled in the art from consideration of the examples of various specific processes and materials disclosed herein.

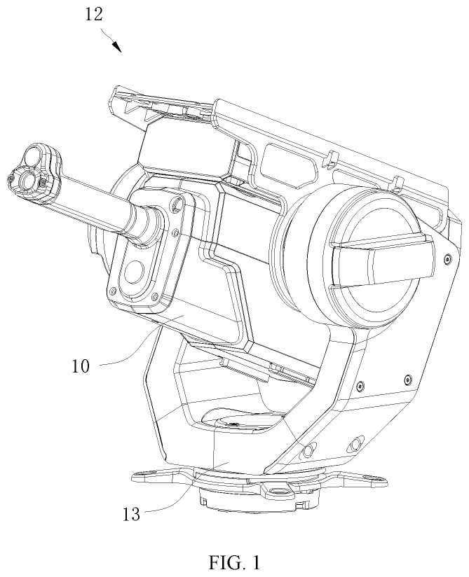

FIG. 1 is a schematic perspective view of an example shooting device 12 consistent with the disclosure. As shown in FIG. 1, the shooting device 12 includes a feeding mechanism 10. The shooting device 12 refers to a device that shoots projectiles. The projectile can include any granular projectile. The projectile can have a sphere shape or a cube shape. The projectile can include a projectile that does not change in shape, such as a metal projectile or a plastic projectile. In some embodiments, the projectile can include a projectile having a changeable shape. For example, the projectile can have a granular solid shape before shot by the shooting device 12, and can become a liquid or a gas after shot by the shooting device 12 and hits a target object, such as water bomb or smoke bomb. The shooting device 12 can be used in various applications, such as entertainment, competition, and the like, to satisfy different requirements of users.

As shown in FIG. 1, the shooting device 12 can be mounted at a movable platform (not shown in FIG. 1). In some embodiments, the shooting device 12 can be mounted at the movable platform via a bracket 13. The bracket 13 can include a gimbal, and the gimbal can include a three-axis, two-axis, or single-axis gimbal. The movable platform may include a device that moves under external force or moves through its own power system. In some embodiments, the movable platform can include an unmanned vehicle. The unmanned vehicle can include an unmanned ground robot, an unmanned aerial vehicle (UAV), or an unmanned boat. The shooting device 12 can be arranged at the movable platform. During a movement of the movable platform, the shooting device 12 can shoot the projectile in a moving state. In some embodiments, the movable platform can control an attitude of the gimbal to adjust a shooting direction of the shooting device 12.

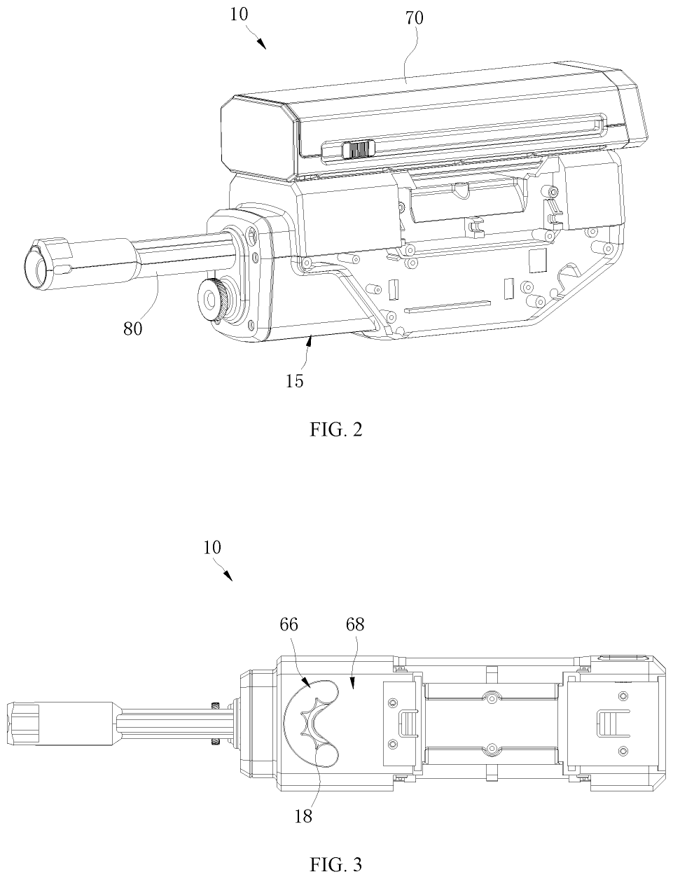

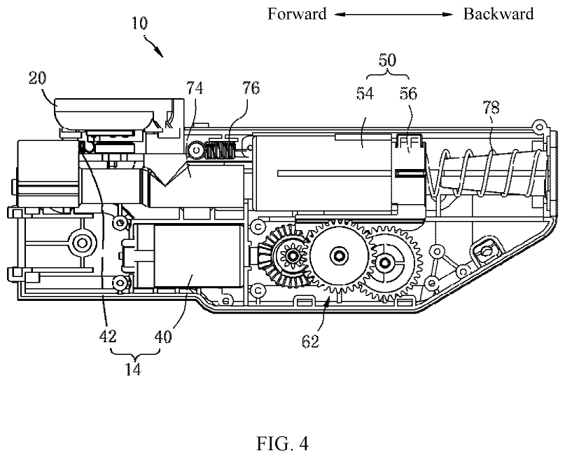

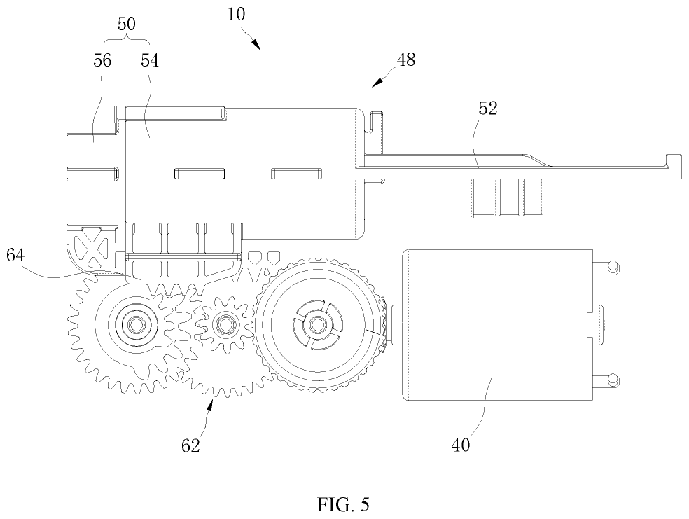

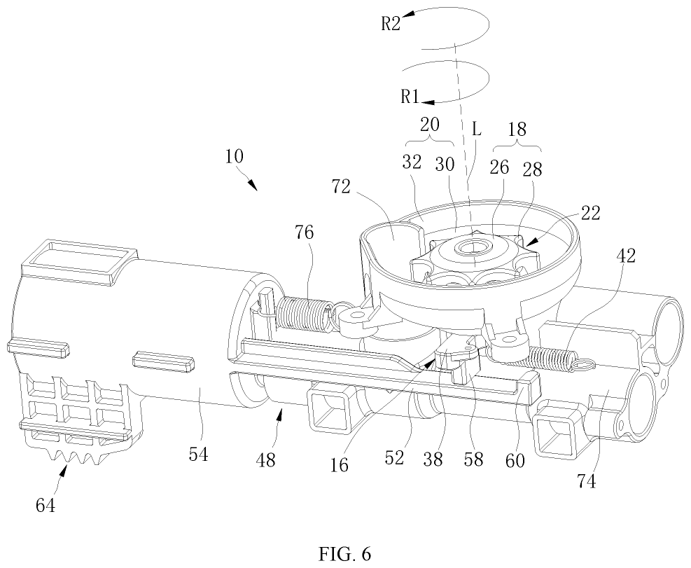

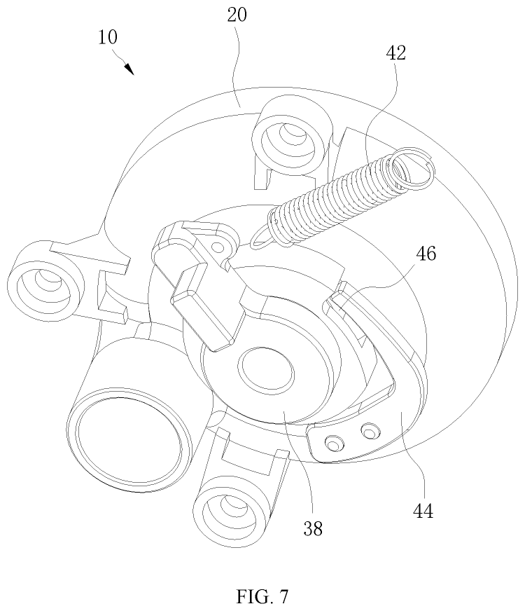

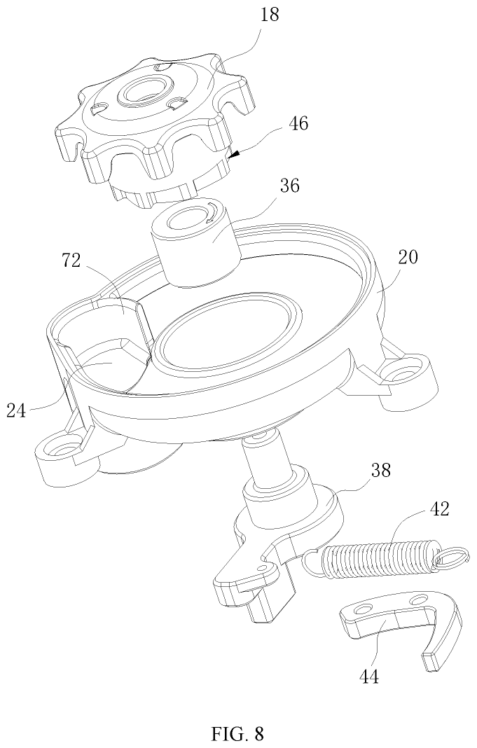

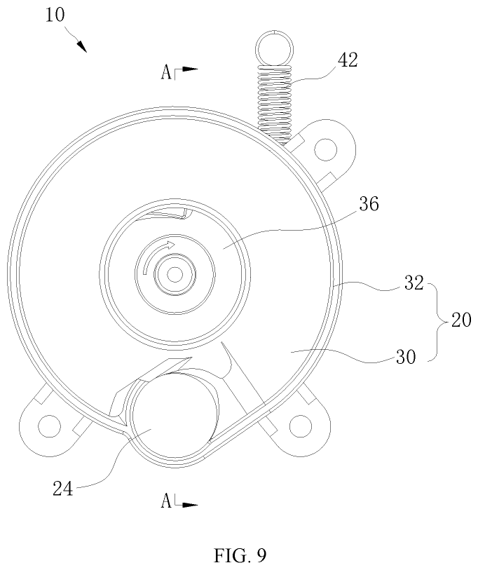

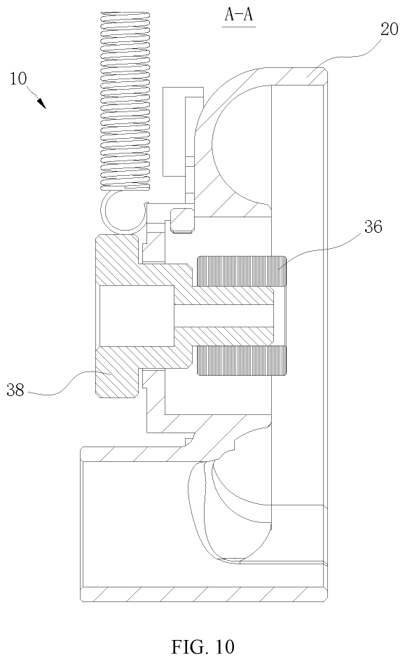

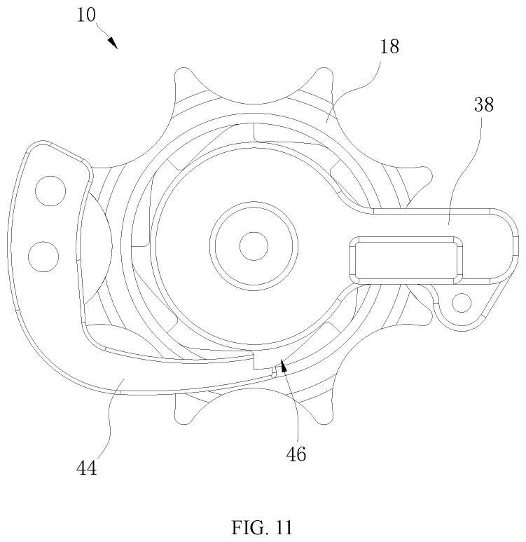

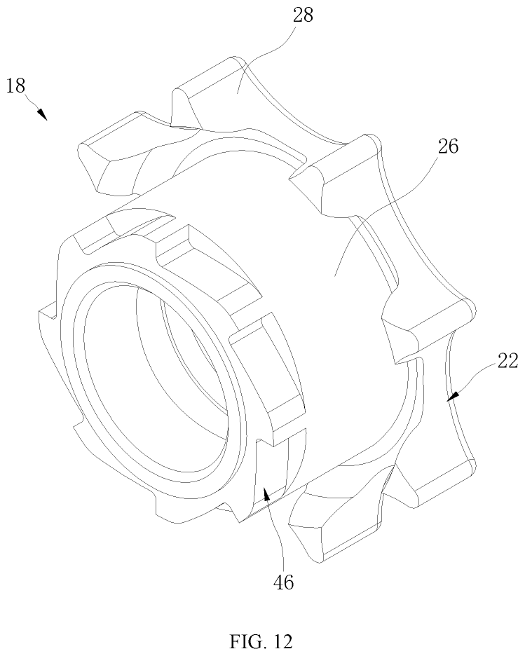

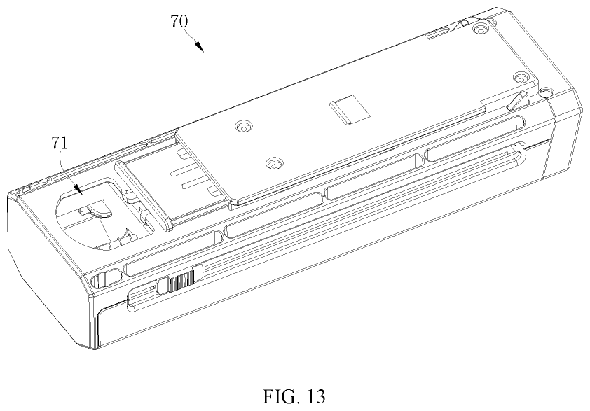

FIG. 2 is a schematic perspective view of the feeding mechanism 10 consistent with the disclosure. FIG. 3 is a schematic plan view of the feeding mechanism 10 consistent with the disclosure. FIG. 4 is a schematic view showing the internal structure of the feeding mechanism 10 consistent with the disclosure. FIG. 5 is a schematic view showing the partial structure of the feeding mechanism 10 consistent with the disclosure. FIG. 6 is a partial perspective view of the feeding mechanism 10 consistent with the disclosure. FIG. 7 is a schematic perspective view of the feeding mechanism 10 from another angle consistent with the disclosure. FIG. 8 is a partially exploded view of the feeding mechanism 10 consistent with the disclosure. FIG. 9 is another partial perspective view of the feeding mechanism 10 consistent with the disclosure. FIG. 10 is a schematic cross-sectional view of the feeding mechanism 10 of FIG. 9 along an A-A direction. FIG. 11 is another schematic view showing the partial structure of the feeding mechanism 10 consistent with the disclosure. FIG. 12 a schematic perspective view of a feeding wheel 18 of the feeding mechanism 10 consistent with the disclosure. FIG. 13 is a schematic perspective view of a magazine 70 of the feeding mechanism 10 consistent with the disclosure.

As shown in FIGS. 2 to 13, the shooting device 12 includes the magazine 70, the feeding mechanism 10, and a barrel 80. The shooting device 12 further includes a shooting body 15. The magazine 70, the feeding mechanism 10, and the barrel 80 are arranged at the shooting body 15. The magazine 70 can be used to store the shooting projectiles. An ejection channel 71 is arranged at the magazine 70. The projectiles stored in the magazine 70 can enter the feeding mechanism 10 from the ejection channel 71. The feeding mechanism 10 can push the projectiles entered from the ejection channel 71 to the barrel 80, and the shooting device 12 can shot the projectiles from the barrel 80.

Hereinafter, a structure of the feeding mechanism 10 will be described in detail. The feeding mechanism 10 includes a power member 14, a transmission assembly 16, a feeding wheel 18, and a feeding disk 20. The feeding disk 20 can be used to receive the projectiles that enter the feeding mechanism 10 from the magazine 70. For example, the feeding disk 20 can be used to receive the projectiles that enter the feeding mechanism 10 from the ejection channel 71. The feeding wheel 18 is mounted at the feeding disk 20, and a feeding section 22 is provided at the feeding wheel 18. For example, the feeding member 22 can be provided along a circumferential direction of the feeding wheel 18.

During an operation of the feeding mechanism 10, the power member 14 can drive the transmission assembly 16 to move. A movement of the transmission assembly 16 can drive the feeding wheel 18 to rotate in single direction, such that the feeding member 22 can push the projectiles accommodated in the feeding disk 20 to a projectile outlet 24. The projectile can enter the barrel 80 from the projectile outlet 24, and the shooting device 12 can shot the projectile from the barrel 80. As such, a unidirectional rotation of the feeding wheel 18 can enable the feeding member 22 to push the projectiles to the projectile outlet 24 in an orderly manner, and the shooting device 12 can avoid multiple shots of projectiles, missed shots of projectiles, and other undesirable phenomena.

As shown in FIGS. 4 and 6, the power member 14 can include any component that outputs power, for example, an electric component such as a servo motor or a stepper motor, or a component that can output power when its physical form is changed. The component that can output power when the physical form is changed may include an elastic member. The elastic member may include a spring, a spring sheet, or the like. The transmission member 16 can include any component capable of generating motion after directly or indirectly receiving the power output from the power member 14. For example, the transmission member 16 may include gears, push rods, guide rails, or the like.

As shown in FIG. 12, the feeding wheel 18 is rotatably provided inside the feeding disk 20, and the feeding wheel 18 is provided with the feeding member 22. The feeding member 22 can be uniformly arranged along the circumferential direction of the feeding wheel 18. In some embodiments, the feeding wheel 18 can have a gear shape, and includes a hub 26 and gear teeth 28. The gear teeth 28 can be arranged at the hub 26 at intervals along the circumferential direction of the hub 26, and the feeding member 22 can be formed between two adjacent gear teeth 28. That is, a receiving groove between two adjacent teeth 28 may be the feeding member 22.

In some embodiments, the feeding member 22 can include an arc-shape groove, and a size of the feeding member 22 may be slightly larger than a size of the projectile to accommodate the projectiles. For example, after the projectile enters the feeding disk 20 from the magazine 70, the projectile can be positioned by the feeding member 22, and can rotate as the feeding member 22 rotates. In some embodiments, there may be a plurality of the feeding members 22. For example, the number of the feeding members 22 can be 5, 6, 7, 8, 10, or the like, which is not limited herein.

As shown in FIGS. 6 and 8, the feeding disk 20 includes a bottom wall 30 and a side wall 32 extending from a periphery of the bottom wall 30. The bottom wall 30 and the side wall 32 surround a projectile-receiving groove 34, and the feeding wheel 18 is housed in the middle of the projectile-receiving groove 34. The projectile outlet 24 is opened on the bottom wall 30. In some embodiments, the projectile outlet 24 can be opened on the side wall 32. The projectile outlet 24 can be located at a radial side of the feeding wheel 18. A size of the projectile outlet 24 can be slightly larger than the size of the projectile, such that the projectile can enter the projectile outlet 24 when the feeding member 22 rotates. For example, when the feeding member 22 rotates, the projectile can be driven to move out of the projectile outlet 24. Under the action of gravity, the projectile can enter the projectile outlet 24. A depth of the projectile-receiving groove 34 is, for example, greater than a diameter of the projectile and less than twice the diameter of the projectile. As such, the projectile-receiving groove 34 can be allowed to house a layer of projectiles, which is beneficial for the feeding wheel 20 to push the projectiles.

In some embodiments, the transmission assembly 16 can be moved periodically under the driving of the power member 14. When the transmission assembly 16 moves periodically, the feeding wheel 18 can be driven to rotate unidirectionally, such that the feeding member 22 can push the projectile accommodated in the feeding disk 20 to the projectile outlet 24 in each cycle. For example, the size of the feeding member 22 may be slightly larger than the size of the projectile to accommodate only one projectile. When the shooting device 12 performs one shot operation (e.g., in a cycle), the transmission assembly 16 can be driven by the power member 14 to move, and when the transmission assembly 16 moves, the feeding wheel 18 can be driven to unidirectionally rotate for a preset angle, such that the feeding member 22 can push one accommodated projectile to the projectile outlet 24.

As such, the feeding member 22 can push one projectile to the projectile outlet 24 in one cycle, such that the shooting device 12 can not only avoid multiple shots of projectiles at the same time in one shot cycle, missed shots of projectiles, and other undesirable phenomena. The cycle refers to a period of time when the shooting device 12 completes a shooting operation.

As shown in FIGS. 8 to 10, in some embodiments, the feeding mechanism 10 includes a unidirectional rotation member 36, and the transmission assembly 16 can drive the feeding wheel 18 to unidirectionally rotate by driving the unidirectional rotation member 36. As such, an effect of the unidirectional rotation of the feeding wheel 18 can be achieved by using the unidirectional rotation member 36.

The unidirectional rotation member 36 may include any component capable of unidirectional transmission. A unidirectional rotation direction of the feeding wheel 18 can be the same as a unidirectional transmission direction of the unidirectional rotation member 36. For example, the unidirectional transmission member 36 may include a unidirectional bearing, and the hub 26 of the feeding disk 20 may be sleeved on an outer ring of the unidirectional bearing to achieve a fixed connection. The inner and outer rings of the unidirectional bearing can rotate freely relative to each other in a first direction, and the unidirectional bearing cannot achieve transmission in the first direction. The inner ring and outer ring of the unidirectional bearing can be relatively locked in a second direction opposite to the first direction and cannot be relatively rotated, and can achieve the unidirectional transmission in the second direction. The second direction refers to a direction in which the feeding wheel 18 unidirectionally rotates.

As shown in FIGS. 6 to 8, in some embodiments, the transmission assembly 16 includes a first transmission member 38 that drives the unidirectional rotation member 36. The first transmission member 38 can be driven, by the power member 14, to move along the first circumferential direction R1 and the second circumferential direction R2 away from the first circumferential direction R1 with a reference axis L as a rotation axis. When the first transmission member 38 moves, the feeding wheel 18 can be driven to unidirectionally rotate, such that the feeding member 22 can push the projectile accommodated in the feeding disk 20 to the projectile outlet 24.

For example, in one cycle, the power member 14 can drive the first transmission member 38 directly or indirectly to rotate along the first circumferential direction R1 and the second circumferential direction R2. When the first transmission member 38 rotates along the first circumferential direction R1 or the second circumferential direction R2, the first transmission member 38 can drive the feeding wheel 18 to rotate unidirectionally via the unidirectional rotation member 36. The unidirectional rotation direction of the feeding wheel 18 can be the first circumferential direction R1 or the second circumferential direction R2. That is, the unidirectional transmission direction of the unidirectional rotation member 36 can be the first circumferential direction R1 or the second circumferential direction R2. As such, under the driving of the first transmission member 38, the feeding wheel 18 can realize the unidirectional rotation.

For example, the hub 26 of the feeding disk 20 can be sleeved on the outer ring of the unidirectional bearing to achieve a fixed connection between the hub 26 and the outer ring. The first transmission member 38 can be connected to the inner ring of the unidirectional bearing, such that the first transmission member 38 can be fixedly connected to the inner ring. When the first transmission member 38 rotates along the first circumferential direction R1 or the second circumferential direction R2, it will drive the inner ring of the bearing to rotate. When the rotation direction of the first transmission member 18 is the same as the transmission direction of the unidirectional bearing, the inner ring of the unidirectional bearing will drive the outer ring of the unidirectional bearing to rotate, thereby driving the feeding wheel 18 to rotate.

For example, the reference axis L refers to the rotation axis of the feeding wheel 18, and the unidirectional rotation direction of the feeding wheel 18 can be the same as the first circumferential direction R1. That is, the transmission direction of the unidirectional rotation member 36 can be the same as the first circumferential direction R1. That is, the feeding wheel 18 can rotate along the first circumferential direction R1. When the first transmission member 38 rotates along the second circumferential direction R2, the feeding wheel 18 can remain stationary, and the first transmission member 38 may return to a first initial position. The first initial position refers to a position of the first transmission member 38 before the first transmission member 38 is rotated along the first circumferential direction R1.

In some embodiments, the unidirectional rotation direction of the feeding wheel 18 may be the same as the second circumferential direction R2. That is, the transmission direction of the unidirectional rotation member 36 can be the same as the second circumferential direction R2. That is, the feeding wheel 18 can rotate along the second circumferential direction R2. When the first transmission member 38 rotates along the first circumferential direction R1, the feeding wheel 18 can remain stationary, and the first transmission member 38 may return to a second initial position. The second initial position refers to a position of the first transmission member 38 before the first transmission member 38 is rotated along the second circumferential direction R2.

As shown in FIGS. 4 to 6, in some embodiments, the power member 14 includes a first power member 40 and a second power member 42. The first transmission member 38 can be driven, by the first power member 40, to rotate along the first circumferential direction R1 with the reference axis L as the rotation axis. The first transmission member 38 can be driven, by the second power member 42, to rotate along the second circumferential direction R2 opposite to the first circumferential direction R1 with the reference axis L as the rotation axis.

As such, the first transmission member 38 can be driven, by the first power member 40 and the second power member 42, to perform a periodic movement, such that the manner in which the first transmission member 38 drives the feeding disk 20 to rotate can be easier to implement. For example, when the first power member 40 drives the first transmission member 38 to rotate along the first circumferential direction R1, the feeding wheel 18 can be driven by the first transmission member 38 to rotate unidirectionally. When the first transmission member 38 is rotated to an extreme position along the first circumferential direction R1, the feeding member 22 can push the projectile to the projectile outlet 24. The second power member 42 can drive the first transmission member 38 to rotate along the second circumferential direction R2. Because the unidirectional rotation member 36 can only rotate in one direction, the feeding wheel 18 can be stationary and the first transmission member 38 can return to the first initial position. As such, the first transmission member 38 can continuously drive the feeding wheel 18 to rotate unidirectional during a reciprocating motion.

In some embodiments, the first power member 40 can include a driving motor 40, and the second power member 42 can include an elastic member 42. That is, the driving motor 40 can drive the first transmission member 38 to rotate along the first circumferential direction R1, and the elastic member 42 can drive the first transmission member 38 to rotate along the second circumferential direction R2. The elastic member 42 can include, for example, a tension spring, a torsion spring, or the like. In some other embodiments, the first power member 40 can include an elastic member, and the second power member 42 can include a driving motor. In some embodiments, the first power member 40 may be an independent power member.

As shown in FIGS. 7, 8, and 11, in some embodiments, a stopper 44 is provided at the feeding disk 20, and a stopper engaging member 46 is provided at the feeding wheel 18. The stopper 44 can cooperate with the stopper engaging member 46 to limit the rotation of the feeding wheel 18 along the second circumferential direction R2. Ideally, if the unidirectional rotation direction of the feeding wheel 18 is the same as the first circumferential direction R1, i.e., if the transmission direction of the unidirectional rotation member 36 is the same as the first circumferential direction R1, because the unidirectional rotation member 36 is a unidirectional transmission member, when the first transmission member 38 rotates along the second circumferential direction R2, the unidirectional rotation member 36 does not drive the feeding wheel 18 to rotate along the second circumferential direction R2. However, in actual engineering practice, due to design and production factors of the unidirectional rotation member 36, the unidirectional rotation member 36 may not be able to fully realize the unidirectional transmission. For example, due to frictions between the inner ring, the outer ring, and a rolling element in the unidirectional bearing, the unidirectional bearing may not fully realize the unidirectional transmission. As such, when the stopper 44 cooperates with the stopper engaging member 46 to limit the rotation of the feeding wheel 18 along the second circumferential direction R2, the unidirectional rotation of the feeding wheel 18 can be more reliably ensured, and the feeding mechanism 10 can be more reliably to push the projectile to the projectile outlet 24.

For example, the stopper 44 can include a pawl, and the stopper engaging member 46 can include a ratchet wheel. A cooperation between the pawl and the ratchet wheel can not only cause the unidirectional rotation of the feeding wheel 18 more reliable, but also limit an angle that the feeding wheel 18 can rotate in each cycle, thereby ensuring that the feeding wheel 18 pushes one projectile out of the projectile outlet 24 in each cycle. For example, the number of gear teeth 28 of the ratchet wheel can be eight. In each cycle, when the ratchet wheel rotates one tooth, the feeding wheel 18 can turn 45 degrees.

In some embodiments, the transmission assembly 16 can further include a second transmission member 48. Driven by the driving motor 40, the second transmission member 48 can drive the first transmission member 38 along one of the first circumferential direction R1 and the second circumferential direction R2 away from the first circumferential direction R1 with the reference axis L as the rotation axis. Driven by the elastic member 42, the first transmission member 38 can rotate along the other one of the first circumferential direction R1 and the second circumferential direction R2 away from the first circumferential direction R1 with the reference axis L as the rotation axis. As such, the driving motor 40 can drive the first transmission member 38 to move via the second transmission member 48, so as to drive the feeding wheel 18 to rotate. The second transmission member 48 can be moved for any driving received directly or indirectly from the driving motor 40, and drive the first transmission member 38 along one of the first circumferential direction R1 and the second circumferential directions R2 away from the first circumferential direction R1. For example, the second transmission member 48 can drive the first transmission member 38 to rotate along the first circumferential direction R1. When the first transmission member 38 is rotated along the first circumferential direction R1, the elastic member 42 connected to the first transmission member 38 can be deformed. When the first transmission member rotates to the extreme position along the first circumferential direction R1, the elastic member 42 can drive the first transmission member 38 to rotate along the second circumferential direction R2 under the action of the elastic force, and the first transmission member can return to the first initial position. In some embodiments, the second transmission member 48 can drive the first transmission member 38 to rotate along the second circumferential direction R2. When the first transmission member 38 is rotated along the second circumferential direction R2, the elastic member 42 connected to the first transmission member 38 can be deformed. When the first transmission member 38 rotates to the extreme position along the second circumferential direction R2, the elastic member 42 can drive the first transmission member 38 to rotate along the first circumferential direction R1 under the action of the elastic force, and the first transmission member 38 can return to the first initial position.

As shown in FIGS. 5 and 6, in some embodiments, the second transmission member 48 includes a piston assembly 50 and a piston transmission member 52 arranged at the piston assembly 50. The piston assembly 50 can be driven by the driving motor 40 and drive the piston transmission member 52 to move. The piston transmission member 52 can drive the first transmission member 38 to rotate along one of the first circumferential direction R1 and the second circumferential directions R2 away from the first circumferential direction with the reference axis L as the rotation axis. The piston transmission member 52 can drive the first transmission member 38 to rotate along the first circumferential direction R1, and the first circumferential direction R1 can be, for example, a clockwise direction as shown in FIG. 6.

As such, the feeding wheel 18 can be linked with the piston assembly 50 via the first transmission member 38, such that the shooting device 12 can not only avoid multiple shots of projectiles, missed shots of projectiles, and other undesirable phenomena, but also facilitate a compact structure of the shooting device 12, thereby causing the device to be more compact.

As shown in FIGS. 5 and 6, the piston assembly 50 includes a piston cylinder 54 and a piston 56 inserting into the piston cylinder 54. The piston transmission member 52 can have an approximately rod shape. The piston transmission member 52 can extend from one end of the piston cylinder 54 to the first transmission member 38 in an axial direction of the piston cylinder 54. A free end of the piston transmission member 52 can be provided with a first projection 58, and the first transmission member 38 can be provided with a second projection 60. The first projection 58 can cooperate with the second projection 60 to cause the piston transmission member 52 to drive the first transmission member 38 to move.

Referring again to FIGS. 4 and 5, the transmission assembly 16 includes a gear assembly 62, and the gear assembly 62 is connected to the driving motor 40. The piston cylinder 54 is provided with a rack 64 meshed with the gear assembly 62, and the driving motor 40 can drive the gear assembly 62 to move, thereby driving the piston cylinder 54 to move.

As shown in FIGS. 3, 8, and 13, in some embodiments, the feeding disk 20 is provided with a projectile inlet 66, and the feeding mechanism 10 further includes a shield member 68 covering the projectile outlet 24. The shield member 68 can be configured to block the projectiles in the magazine 70 from directly entering the projectile outlet 24. That is, the shield member 68 can block the projectiles in the magazine 70 that enter the projectile mechanism 10 via the ejection channel 71 from directly entering the projectile outlet 24 without passing the feeding disk 20. As such, the shield member 68 can prevent the shooting device 12 from shooting multiple projectiles each time.

The projectile inlet 66 can be in communication with the feeding disk 20, and the projectiles in the magazine 70 can fall into the feeding disk 20 through the feeding inlet 66. The shield member 68 can have, for example, a plate-like shape. The projectile inlet 66 can be located at a side of the shield member 68. The projectile inlet 66 can have, for example, an arc shape, a square shape, or the like.

As shown in FIGS. 6 and 8, in some embodiments, the projectile outlet 24 is provided with a blocking member 72 for limiting the projectiles pushed to the projectile outlet 24 from moving in the unidirectional rotation direction of the feeding wheel 18. For example, the blocking member 72 can have a sheet-like shape, and the blocking member 72 can extend from the side wall 32 to the feeding wheel 18. The blocking member 72 can be located at one side of the projectile outlet 24. When the feeding wheel 18 pushes the projectile to cause the projectile to be located at the projectile outlet 24, the projectile can enter the projectile outlet 24 under the pressure of the blocking member 72 and the feeding wheel 18 due to the blocking of the blocking member 72. The blocking member 72 and the feeding disk 20 may be an integrated structure, so that the blocking member 72 can be easily formed.

Referring again to FIGS. 4 and 6, in some embodiments, the feeding mechanism 10 includes a three-way pipe 74. The piston cylinder 54, and the projectile outlet 24 can be in communication with the three-way pipe 74. As such, after the projectile falls into the three-way pipe 74 through the projectile outlet 24, the piston 56 can rapidly compresses air during the movement, thereby shooting the projectile from the three-way pipe 74.

As shown in FIGS. 4 and 6, the working process of the feeding mechanism 10 can be as follows. The driving motor 40 can drive the gear assembly 62 to rotate to drive the piston cylinder 54 and the piston 56 to move backward at the same time. While the piston cylinder 54 is moving backward, the piston transmission member 52 can drive the first transmission member 38 to move, thereby driving the feeding wheel 18 to rotate, and a first reset spring 76 can be stretched to accumulate energy. During the backward movement of the piston cylinder 54 to the extreme position, the feeding wheel 18 can simultaneously push the projectile into the projectile outlet 24, such that the projectile can enter the three-way pipe 74. While the gear assembly 62 continues to rotate, the rack 64 on the piston cylinder 54 can be disengaged from the gear assembly 62, and the piston cylinder 54 can be reset by the first return spring 76. The piston cylinder 54 can suck in ambient air during the resetting process, and the piston 56 can continue to move backward and compress a second reset spring 78 under the push of the gear assembly 62. When the piston 56 moves backward to the extreme position, the piston 56 can be disengaged from the gear assembly 62. Under the action of the second reset spring 78, the piston 56 can move forward rapidly to compress the air in the piston cylinder 54, and the compressed air can be injected into the three-way pipe 74 to shoot the projectile in the three-way pipe 74 from the barrel 80. Repeat the processes described above, shooting the projectiles one by one and continuously can be realized.

As used herein, the terms “certain embodiment,” “an embodiment,” “some embodiments,” “an example,” “certain example,” “some examples,” or the like, refer to that the specific features, structures, materials, or characteristics described in connection with the embodiments or examples are included in at least one embodiment or example of the disclosure. The illustrative representations of the above terms are not necessarily referring to the same embodiments or examples. Furthermore, the specific features, structures, materials, or characteristics described may be combined in a suitable manner in any one or more embodiments or examples. In the situation where the features described in the embodiments are not conflicting, they can be combined.

It is intended that the embodiments disclosed herein be considered as example only and not to limit the scope of the disclosure. Changes, modifications, alterations, and variations of the above-described embodiments may be made by those skilled in the art within the scope of the disclosure.

What is claimed is:

1. A feeding mechanism of a shooting device comprising:
a feeding disk;
a feeding wheel arranged at the feeding disk and including a feeding member; and
a transmission assembly configured to drive the feeding wheel to rotate unidirectionally, to cause the feeding member to push a projectile accommodated in the feeding disk to a projectile outlet.

2. The feeding mechanism of claim 1, further comprising:
a power member configured to drive the transmission assembly to move.

3. The feeding mechanism of claim 2, wherein:
the power member is configured to drive the transmission assembly to move periodically;
the transmission assembly is configured to move periodically to drive the feeding wheel to rotate unidirectionally, to cause the feeding member to push the projectile to the projectile outlet in one cycle.

4. The feeding mechanism of claim 2, further comprising:
a unidirectional rotation member;
wherein the transmission assembly is configured to drive the feeding wheel to rotate unidirectionally by driving the unidirectional rotation member.

5. The feeding mechanism of claim 4, wherein the unidirectional rotation member includes a unidirectional bearing.

6. The feeding mechanism of claim 4, wherein:
the transmission assembly includes a transmission member configured to be driven by the power member to rotate about a reference axis along a first circumferential direction or a second circumferential direction opposite to the first circumferential direction; and
the transmission member is further configured to, when rotating, drive the feeding wheel to rotate unidirectionally to cause the feeding member to push the projectile to the projectile outlet.

7. The feeding mechanism of claim 6, wherein:
the reference axis includes a rotation axis of the feeding wheel; and
an unidirectional rotation direction of the feeding wheel is same as the first circumferential direction.

8. The feeding mechanism of claim 7, wherein:
the feeding disk includes a stopper; and
the feeding wheel includes a stopper engaging member configured to cooperate with the stopper to limit a rotation of the feeding wheel along the second circumferential direction.

9. The feeding mechanism of claim 8, wherein:
the stopper includes a pawl; and
the stopper engaging member includes a ratchet wheel.

10. The feeding mechanism of claim 6, wherein:
the power member includes a first power member and a second power member; and
the transmission member is configured to:
be driven by the first power member to rotate about the reference axis along the first circumferential direction; and
be driven by the second power member to rotate about the reference axis along the second circumferential direction.

11. The feeding mechanism of claim 10, wherein:
the first power member includes one of a driving motor and an elastic member; and
the second power member includes another one of the elastic member and the driving motor.

12. The feeding mechanism of claim 11, wherein:
the transmission member is a first transmission member;
the transmission assembly further includes a second transmission member configured to be driven by the driving motor to drive the first transmission member to rotate about the reference axis along one of the first circumferential direction and the second circumferential direction; and
the first transmission member is configured to be driven by the elastic member to rotate about the reference axis along another one of the first circumferential direction and the second circumferential direction.

13. The feeding mechanism of claim 12, wherein the second transmission member includes:
a piston assembly configured to be driven by the driving motor to move; and
a piston transmission member arranged at the piston assembly and configured to be driven by the piston assembly to drive the first transmission member to rotate about the reference axis along the first circumferential direction or the second circumferential direction.

14. The feeding mechanism of claim 1, further comprising:
a shield member covering the projectile outlet and configured to block the projectile from directly entering the projectile outlet.

15. The feeding mechanism of claim 1, wherein the feeding wheel is arranged inside the feeding disk.

16. The feeding mechanism of claim 1, wherein the feeding member includes an arc-shape groove.

17. The feeding mechanism of claim 1, wherein the feeding member is one of a plurality of feeding members uniformly arranged along a circumferential direction of the feeding wheel.

18. The feeding mechanism of claim 1, wherein:
the projectile outlet includes a blocking member configured to limit the projectile pushed to the projectile outlet from moving in a unidirectional rotation direction of the feeding wheel.

19. A shooting device comprising:
a feeding mechanism including:
a feeding disk;
a feeding wheel arranged at the feeding disk and including a feeding member; and
a transmission assembly configured to drive the feeding wheel to rotate unidirectionally, to cause the feeding member to push a projectile accommodated in the feeding disk to a projectile outlet.

20. An unmanned vehicle comprising:
a body;
a gimbal arranged at the body; and
a shooting device arranged at the gimbal and including a feeding mechanism including:
a feeding disk;
a feeding wheel arranged at the feeding disk and including a feeding member; and
a transmission assembly configured to drive the feeding wheel to rotate unidirectionally, to cause the feeding member to push a projectile accommodated in the feeding disk to a projectile outlet.
